(19) United States
(12) Patent Application Publication
(10) Pub. No.: US 2009/0096807 A1
(43) Pub. Date: Apr. 16, 2009

(54) Systems and methods for image colorization

(76) Inventors: Jonathan C. Silverstein, Chicago, IL (US); Nigel M. Parsad, Chicago, IL (US)

Correspondence Address: FULBRIGHT & JAWORSKI L.L.P., 600 CONGRESS AVE., SUITE 2400, AUSTIN, TX, 78701, US

(21) Appl. No.: 12/229,876

(22) Filed: Aug. 27, 2008

Related U.S. Application Data
(60) Provisional application No. 60/966,276, filed on Aug. 27, 2007.

(51) Int. Cl. G09G 5/02

(52) U.S. Cl. 345/593

(57) ABSTRACT

Systems and methods for colorizing an image. In one embodiment, a method for colorizing an image comprises assigning a first color from a first color map to a data point to define a first graphical element, assigning a second color from a perceptual color map to the data point to define a second graphical element, calculating a first luminance for the first graphical element, calculating a second luminance for the second graphical element, adjusting a brightness associated with the first graphical element until the first luminance and the second luminance match within a first predetermined range, and adjusting a saturation associated with the first graphical element until the first luminance and the second luminance match within a second predetermined range.

### CROSS REFERENCE TO RELATED APPLICATIONS

This application claims priority to U.S. Provisional Application No. 60/966,276 filed Aug. 27, 2007, the entire contents of which are specifically incorporated by reference herein without disclaimer.

### STATEMENT REGARDING FEDERALLY SPONSORED RESEARCH OR DEVELOPMENT

This invention was made with government support under grant number NO 1-LM-3-3508 awarded by the National Institutes of Health (NIH). The government has certain rights in the invention.

### BACKGROUND OF THE INVENTION

1. Field of the Invention

The present invention relates generally to image processing and, more particularly, to systems and methods for image colorization.

2. Description of Related Art

The use of grayscale color maps to delineate computed tomography (CT) density data in radiological imaging is ubiquitous. Dating back to x-ray films, the mapping of the grayscale color spectrum to tissue density value was historically the only color map visualization option for medical image analysis. An accordingly broad scope of diagnostic imaging tools and techniques based upon grayscale two-dimensional (2D) image interpretation was thus established. Nevertheless, current generation radiological workstations offer preset color map options beyond traditional grayscale. With the advent of fast, multi-detector CT scanners and cost effective, high performance computer graphics hardware, these proprietary workstations can reconstruct detailed three-dimensional (3D) volume rendered objects directly from 2D high-resolution digital CT slice images.

### BRIEF SUMMARY OF THE INVENTION

The example embodiments provide systems and methods for image colorization. In one embodiment, a method for colorizing an image comprises assigning a first color from a first color map to a data point to define a first graphical element, assigning a second color from a perceptual color map to the data point to define a second graphical element, calculating a first luminance for the first graphical element, calculating a second luminance for the second graphical element, adjusting a brightness associated with the first graphical element until the first luminance and the second luminance match within a first predetermined range, and adjusting a saturation associated with the first graphical element until the first luminance and the second luminance match within a second predetermined range. In a further embodiment, adjusting the saturation may be performed in response to a determination that the brightness parameter associated with the first graphical element has reached a threshold value. In a specific embodiment, the first predetermined range is equal to the second predetermined range.

For example, the example embodiments provide methods and systems capable of taking generic field data (e.g., temperature maps for weather or 3-D field data such as CT scans) and an arbitrary map of the data to a color and applying perceptual contrast theory to adjust the colors for display of the data to be perceptually correct across a continuous spectrum, and in so doing gain the contrast-enhancement typical of grayscale images without losing color.

In one embodiment, the method may include recalculating the first luminance iteratively after an adjustment of one of the brightness and the saturation of the first graphical element. The method may also include selecting a subset of data points from a multidimensional dataset, the subset of data points having values within a specified range of values. In a certain embodiment, the multidimensional dataset is associated with a radiological image.

In still another embodiment the method may include excluding one or more of the data points from the subset of data points. In these various embodiments, the first color map may include colors that mimic coloration of an anatomic feature of a human body. For example, Table 1 below describes a color map that may mimic coloration of an anatomic feature of the human body. The perceptual color map may include a grayscale color map. Nonetheless, one of ordinary skill in the art will recognize that other perceptual color maps may be used in conjunction with the example embodiments.

The example embodiments may be used in multichannel operation as well. Indeed, the example embodiments may be expandable to up to N channels of operation. For example, the method may include assigning a third color to a second data point generated by a multichannel data source to define a third graphical element, assigning a fourth color from a perceptual color map to the data point to define a fourth graphical element, calculating a third luminance for the third graphical element, calculating a fourth luminance for the fourth graphical element, adjusting a brightness associated with the third graphical element until the third luminance and the fourth luminance match, adjusting a saturation associated with the third graphical element until the third luminance and the fourth luminance match in response to a determination that the brightness parameter associated with the third graphical element has reached a threshold value, and displaying one of the first graphical element and the third graphical element according to a predetermined display scheme. In a further embodiment, adjusting the saturation is performed in response to a determination that the brightness parameter associated with the first graphical element has reached a threshold value.

In an alternative embodiment, a method for image coloration may include assigning a first color from a first color map to a data point to define a first graphical element, assigning a second color from a perceptual color map to the data point to define a second graphical element, calculating a first luminance for the first graphical element, calculating a second luminance for the second graphical element, calculating a target luminance according to selectable weights of the first luminance and the second luminance, adjusting a brightness associated with the first graphical element until the first luminance and the target luminance match, and adjusting a saturation associated with the first graphical element until the first luminance and the second luminance match.

In one embodiment, adjusting the saturation is performed in response to a determination that the brightness parameter associated with the first graphical element has reached a threshold value. Additionally, the weights may be selected through a user adjustable interface control. In a specific embodiment, the interface control comprises a slider.

An apparatus for image coloration is provided. The apparatus may include a memory for storing a data point associated with an image. Additionally, the apparatus may include a processor, coupled to the memory. The processor may be configured to assign a first color from a first color map to a data point to define a first graphical element, assign a second color from a perceptual color map to the data point to define a second graphical element, calculate a first luminance for the first graphical element, calculate a second luminance for the second graphical element, adjusting a brightness associated with the first graphical element until the first luminance and the second luminance match within a first predetermined range, and adjust a saturation associated with the first graphical element until the first luminance and the second luminance match within a second predetermined range. In a further embodiment, adjusting the saturation is performed in response to a determination that the brightness parameter associated with the first graphical element has reached a threshold value.

In one embodiment, the apparatus may include an image capture device configured to capture the image. The image capture device may include a multichannel image capture device. The apparatus may also include a display configured to display a colorized image. In a certain embodiment, the apparatus includes a user interface configured to allow a user to select a combination of the first luminance and the second luminance for calculating a target luminance.

A computer readable medium comprising computer-readable instructions that, when executed, cause a computing device to perform certain steps is also provided. In one embodiment, those steps include assigning a first color from a first color map to a data point to define a first graphical element, assigning a second color from a perceptual color map to the data point to define a second graphical element, calculating a first luminance for the first graphical element, calculating a second luminance for the second graphical element, adjusting a brightness associated with the first graphical element until the first luminance and the second luminance match within a first predetermined range, and adjusting a saturation associated with the first graphical element until the first luminance and the second luminance match within a second predetermined range. In a further embodiment, the adjusting the saturation is performed in response to a determination that the brightness parameter associated with the first graphical element has reached a threshold value.

The term “coupled” is defined as connected, although not necessarily directly, and not necessarily mechanically. The terms “a” and “an” are defined as one or more unless this disclosure explicitly requires otherwise. The terms “substantially,” “approximately,” “about,” and variations thereof are defined as being largely but not necessarily wholly what is specified, as understood by a person of ordinary skill in the art. In one non-limiting embodiment, the terms substantially, approximately, and about refer to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but it may also be configured in ways other than those specifically described herein.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

For a more complete understanding of embodiments of the present invention, reference is now made to the following drawings, in which:

FIGS. 1(a)-(g) are color images that illustrate a comparison between the use of generic and perceptual color maps, according to one illustrative embodiment of the present invention.

FIGS. 2(a) and (b) are color images that illustrate generic realistic and perceptual grayscale color map visualizations viewed downward at the upper thoracic cavity according to one illustrative embodiment of the present invention.

FIG. 3 is a screenshot of a graphical user interface (GUI) for a Volume Visualization Engine according to one illustrative embodiment of the present invention.

FIG. 4 is a color graph of RGB values including interpolated regions from Table 1, according to one illustrative embodiment of the present invention.

FIG. 5 is a color graph of luminance versus HU units according to one illustrative embodiment of the present invention.

FIGS. 6(a)-(c) are color images of perceptual grayscale, generic realism, and perceptual realism images of a leg, respectively, according to one embodiment of the present invention.

FIG. 7 is a flowchart of a method for colorizing an image according to one embodiment of the present invention.

FIG. 8 is a block diagram of a computer system for implementing certain embodiments of the present invention.

### DETAILED DESCRIPTION OF THE INVENTION

In the following detailed description, reference is made to the accompanying drawings that illustrate embodiments of the present invention. These embodiments are described in sufficient detail to enable a person of ordinary skill in the art to practice the invention without undue experimentation. It should be understood, however, that the embodiments and examples described herein are given by way of illustration only, and not by way of limitation. Various substitutions, modifications, additions, and rearrangements may be made without departing from the spirit of the present invention. Therefore, the description that follows is not to be taken in a limited sense, and the scope of the present invention is defined only by the appended claims.

As used herein, the term “color map” includes a predetermined selection of colors for assignment to a data point, where the color assignment is made based on the value of the data point. For example, a data point having a value within a first range may be assigned the color red, while a data point having a value within a second range may be assigned the color yellow.

As used herein, the term “perceptual color map” means a color map in which a single color inherently includes human perceivable differences in intensity. For example a perceptual color map may include a grayscale color map.

As used herein, the term “data point” includes data associated with an image or capable of rendering an image, alone or in combination with other information. The data may be a single bit. Alternatively, the data may include a byte, word, or structure of bits, bytes, or words. For example, in a radiological data set, a data point may include a value that corresponds to a density value of a scanned object.

As used herein, the term “graphical element” includes a color value assigned to a data point. The color value may include an RGB defined color value. Alternatively, the graphical element may include an HSV/HSB defined color value. A typical graphic element may be a voxel in a volumetric dataset or pixel in a two-dimensional image, but may also be an abstract visualization primitive such as a cube or a pixel projected on to a geometric surface.

As used herein, the term “brightness” includes an HSB defined brightness parameter of a color. Alternatively, brightness may be defined as the HSV defined Value parameter of a color.

As used herein, the term “saturation” includes the HSB/HSV defined saturation parameter of a color.

As used herein, the term “multichannel” includes data from multiple data sources that are either co-located, aggregated, or combined in some relationship for generating a displayable image. For example, in a radiological application, a multichannel dataset may include the same physical object (e.g. the head) imaged by CT, MRI, and PET, thus there are separate streams of data points for each spatial location. In a meteorological application, this may include precipitation, temperature, wind speed, and humidity for one geographic point.

The term “target luminance” includes a luminance value that has been designated for matching within a range.

As used herein, the term “predetermined display scheme” refers to a method or algorithm for determining an process or order of displaying perceptually corrected graphical elements from multiple data sources. For example, Maximum Intensity Projection may create a multi-color perceptually correct rendering of the original multi-channel data.

Although radiological devices offer preset color map options beyond grayscale, most of these color maps have little additional diagnostic or intuitive value relative to grayscale. In fact, certain color maps can actually bias interpretation of 2D/3D data. A common example is the spectral colorization often seen representing temperature range on weather maps [1]. Other preset colorization algorithms are merely ad hoc aesthetic creations with no pragmatic basis for enhancing data visualization and analysis. A need exists for, among other things, a density-based, perceptually accurate, color map based on anatomic realism.

1. Human Physiology and Color Perception

Human color vision is selectively sensitive to certain wavelengths over the entire visible light spectrum. Furthermore, a person's perception of differences in color brightness is non-linear between hues. As a result, color perception is a complex interaction incorporating the brain's interpretation of the eye's biochemical response to the observed spectral power distribution of visible light. The spectral power distribution is the incident light's brightness per unit wavelength and is denoted by I(λ). I(λ) is a primary factor in characterizing a light source's true brightness and is proportional to E(λ), the energy per unit wavelength. The sensory limitations of retinal cone cells combined with a person's non-linear cognitive perception of I(λ) are fundamental biases in conceptualization of color.

Cone response is described by the trichromatic theory of human color vision. The eye contains 3 types of photoreceptor cones that are respectively stimulated by the wavelength peaks in the red, green or blue bands of the visible light electromagnetic spectrum. As such, trichromacy produces a weighted sensitivity response to I(λ) based upon the RGB primary colors. This weighting is the luminous efficiency function (V(λ)) of the human visual system. The CIELAB color space recognizes the effect of trichromacy on true brightness via its luminance (Y) component. Luminance is the integral of the I(λ) distribution multiplied by the luminous efficiency function and may be summarized as an idealized human observer's optical response to the actual brightness brightness of light [2]:

Y=∫I(λ)V(λ) where: ˜400 nm<λ<700 nm Eq. (1)

Empirical findings from the field of visual psychophysics show that the human perceptual response to luminance follows a compressive power law curve derived by Stevens [3]. As luminance is simply the true brightness of the source weighted by the luminosity efficiency function, it follows that people perceive true brightness in a non-linear manner. A percentage increase in the incident light brightness is not cognitively interpreted as an equal percentage increase in perceived brightness. CIELAB incorporates this perceptual relationship in its lightness component L*, which is a measure of perceived brightness:

L*=116(Y/Yn)1/3−16 where: 8.856×10-2<Y/Yn Eq. (2)

Here Yn is the luminance of a white reference point in the CIELAB color space. The cube root of the luminance ratio Y/Yn approximates the compressive power law curve, e.g., a source having 25% of the white reference luminance is perceived to be 57% as bright. Note that for very low luminance, where the relative luminance ratio is lower than 8.856×10-2, L* is approximately linear in Y. To summarize, Y and L* are sensory defined for the visual systems of living creatures and light sensitive devices whereas I(λ) is an actual physical attribute of electromagnetic radiation.

CT scanners measure the X-ray radiodensity attenuation values of body tissue in Hounsfield units (HU). In a typical full body scan, the distribution of Hounsfield units ranges from −1000 for air to 1000 for cortical bone [4]. Distilled water is zero on the Hounsfield scale. Since the density range for typical CT datasets spans approximately 2000 HU and the grayscale spectrum consists of 256 colors, radiologists are immediately faced with a dynamic color range challenge for CT image data. Mapping 2000 density values onto 256 shades of gray results in an under constrained color map. Lung tissue; for example, cannot be examined concurrently with the cardiac muscle or vertebrae in grayscale because the thoracic density information is spread across too extreme a range. Radiologists use techniques such as density windowing and opacity ramping to interactively increase density resolution.

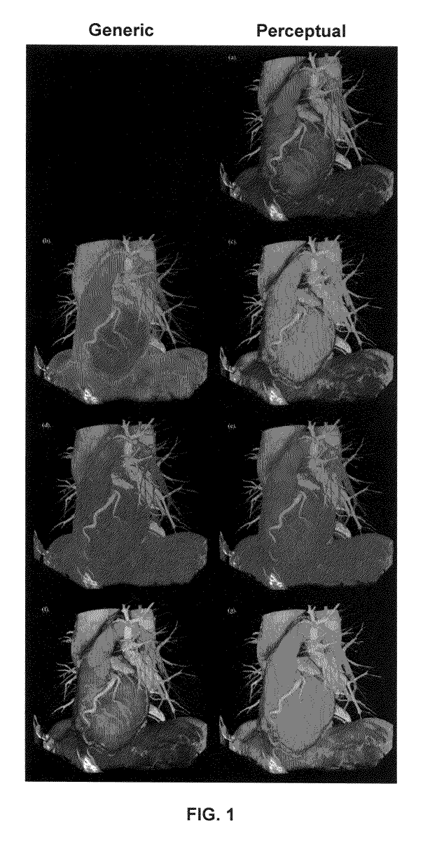

However, just as it is impossible to examine a small structure at high zoom without losing the rest of the image off the screen, it is impossible to examine a narrow density window without making the surrounding density information invisible. Vertebral features are lost in the lung window and vice-versa. This problem compounds itself as you scroll through the dataset slice images. A proper window setting in a chest slice may not be relevant in the colon, for example. One must continually window each dissimilar set of slices to optimize observation. Conventional density color maps can accomplish this but the visualizations are often unnatural and confusing—it is almost easier to look at them one organ at a time in grayscale. Fortunately radiologists can focus their scanning protocols on small sections of the anatomy where they can rely on known imaging parameters to compress dynamic range. However, without a radiology background, it is not obvious what parameters are needed to view specific anatomical features, let alone the entire body. This problem is exacerbated in 3D as the imaging complexity of the anatomical visualization substantially increases with the extra degree of spatial freedom. For example, the volume rendered heart shown in FIG. 1 contains tissue densities including fat, cardiac muscle, and cardiac vasculature in a relatively compact space. If the region of interest around the heart is extended, then vertebrae, bronchia, and liver parenchyma are immediately incorporated into the visualization. This increases the parameter space of visualization data considerably with just a small spatial addition of volume rendered anatomy. A modern computer display can produce millions of colors and thus overcome the challenge of wide dynamic range HU visualizations. This is especially important in 3D volume renderings as you generally view large anatomical regions at once. Intuitive mapping of color to voxel density data becomes a necessity, as simply mapping a generic color map onto human tissue HU values does not guarantee insightful results.

Color realism may be advantageous for surgeons' perceptions as they predominantly examine tissue either with the naked eye or through a CCD camera. A known visualization obstacle in the surgical theater is that a bloody field is difficult to see even in the absence of active bleeding or oozing. A simple rinsing of the field with saline brings forth an astounding amount of detail. This is because dried blood covering the tissues scatters the incident light, obscures the texture, and conceals color information. All of the typical color gradients of yellow fat, dark red liver, beefy red muscle, white/bluish tint fascia, pale white nerves, reddish gray intestine, dark brown lung, and so on become a gradient of uniform red which is nearly impossible to discriminate with a naked eye. This lack of natural color gradients is precisely the reason why grayscale and spectral colorizations cannot provide the perceptive picture of the anatomy no matter how sophisticated the 3D reconstruction. Realistic colorization is also useful in rapidly identifying organs and structures for spatial orientation. Surgeons use several means for this purpose: shape, location, texture, and color. Shape, location, and, to some extent texture, are provided by the 3D visualization. However, this information may not be sufficient in all circumstances. Specifically, when looking at a large organ in close proximity, color information becomes invaluable and realism becomes key. A surgeon's visual perception is entrained to the familiar colors that remain relatively constant between patients. Surgeons do not consciously ask themselves what organ corresponds to what color. For this reason, every laparoscopist begins a case by white balancing the camera. When looking at a grayscale CT image, one has to look at the shade of the object with respect to the known structures in order to identify it. Fluid in the peritoneal cavity, for example, may be blood, pus, or ascites. Radiologists must explicitly measure the density of the fluid region in Hounsfield units since the shape, location, and texture are lost if realistic color information is not available.

Anatomically realistic color maps also allow for a wider perceivable dynamic visualization range at extreme density values. Consider that a volume reconstruction of the vertebrae, cardiac structure, and air-filled lung tissues may be displayed concurrently in fine detail with realistic colorization, i.e., the thoracic cardiac region would find the vertebrae mapped to white, cardiac muscle to red, fat to yellow, and the lung parenchyma to pink. Air would be transparent. Another application of color mapping in accordance with the example embodiments is with intracorporeal visualization where volume renderings of the bone trabeculae, lung parenchyma, and myocardial surface may be viewed in the same 3D reconstruction.

Object discrimination on the basis of color becomes especially important when clipping planes and density windowing are used to look at the parenchyma of solid organs or to “see through” the thoracic cage, for instance.

These techniques allow unique visualization of intraparenchymal lesions and tracing of the vessels and ducts at oblique angles. However, one can easily lose orientation and spatial relationship between these structures in such views. Color realism of structures maintains this orientation for the observer as natural colors obviate the need to question whether the structure is a bronchus or a pulmonary artery or vein.

Despite the advantage of realistic colorization in the representation and display of volume rendered CT data, grayscale remains inherently superior with regard to two important visualization criteria. Research in the psychophysics of color vision suggests that color maps with monotonically increasing luminance, such as CIELAB and HSV grayscale, are perceived by observers to naturally enhance the spatial acuity and overall shape recognition of facial features [5]. Although these studies were only done on two-dimensional images, due to the complexity of facial geometry, this study may be a good proxy for pattern recognition of complex organic shapes in 3D anatomy.

Findings also suggest that color maps with monotonically increasing luminance are ideal for representing interval data [1]. The HU density distribution and the Fahrenheit temperature scale are examples of such data. Interval data may be defined as data whose characteristic value changes equally with each step, e.g., doubling the Fahrenheit temperature results in a temperature twice as warm [6]. A voxel with double the HU density value relative to another is perceptually represented by a color with proportionally higher luminance. In accordance with Eq. (2) the denser voxel may also have a higher perceived brightness. Grayscale color maps in medical imaging and volume rendering are therefore perceptual as luminance, and thus perceived brightness, increases monotonically with tissue density pixel/voxel values.

Secondly, whether the HU data spans the entire CT range of densities or just a small subset (i.e. “window”) of the HU range, the gamut of grayscale's perceived brightness (L*) is maximally spread from black to white. Color vision experiments with human observers show that color maps with monotonically increasing luminance and a maximum perceived brightness contrast difference greater than 20% produced data colorizations deemed most natural [5]. Color scales with perceived brightness contrast that are below 20% are deemed confusing or unnatural regardless of whether their luminance increases monotonically with the underlying interval data. From these two empirical findings, it appears that grayscale colorization may be the most effective color scale for HU density data.

However, for anatomical volume rendering, grayscale conveys no sense of realism thus leading to a distracting degree of artificialness in the visualization. Generic spectral and anatomically realistic hued color maps are not maximized for perceived brightness contrast and do not scale interval data with increasing monotonicity in luminance. For example, the perceived brightness of yellow in the aforementioned temperature map is higher than the other spectral colors. This leads to a perceptual bias as the temperature data represented by yellow pixels appears inordinately brighter compared to the data represented by shorter wavelength spectral hues. A perceptually based color map should typically mimic the CIELAB/HSV linearly monotonic grayscale relationship between luminance and interval data value while optimizing luminous contrast. Thus, preferred embodiments incorporate these two perceptual criteria into an anatomically realistic colorization process.

2. Overview

The luminance matching, colorization method described herein according to one embodiment, automatically generates color maps with any desired luminance profile. It also converts the luminance profile of existing color maps in real-time if given their RGB values. Examples of generable luminance profiles include, but are not limited to: i) perceptual color maps with monotonically increasing luminance over a given span of interval data. Monotonically increasing functions are defined as those whose luminance range is single-valued with the interval data domain in question, i.e., linear, logarithmic, or exponential luminance profiles; ii) isoluminant color maps where the luminance is constant over a given data span. The underlying data need not be of the interval type; iii) discrete data range luminance color maps where the luminance follows a specific function for different ranges of the underlying data. One part of the displayed data may have a different luminance profile than the other. Again, the data need not be interval; and iv) arbitrarily shaped luminance profiles generated by either mathematical functions or manual selection.

A common example of a non-perceptual and non-isoluminant color map is the spectral color scheme that orderly displays the colors in the rainbow. With luminance matching, this spectral colorization may be converted to a perceptual, isoluminant, discrete data range, or any other type of color map depending on the desired output luminance profile.

Colorization methods disclosed herein may be applied to real-time, 3D, volume rendered, stereoscopic, distributed visualization environments and allows for interactive luminance matching of color-mapped data. However, the process may be easily incorporated into imaging visualization software where color tables are used to highlight data. One embodiment of a luminance matching method may also be applied to two-dimensional visualization environments as well as environments that render two- and three-dimensional representations of higher dimensional datasets.

Colorization processes may also be designed to maximize the luminance contrast of the color map generated. Whether the color map spans the entire dataset or just a small subset (i.e. “window”) of the dataset, the perceived brightness (L*) is maximally spread from 0% to 100% luminance, thus maximizing perceptual contrast.

3. General Application

One embodiment of a luminance matching colorization process may be applied to a hue-based (i.e., non-grayscale) color map that represents underlying single or multi-dimensional data. Examples of applications include, but are not limited to; i) two-dimensional slice imaging and multidimensional volume rendering of medical and veterinary data including, but not limited to, those generated by X-rays, CT, MR, PET and ultrasound, and organic and inorganic data including but not limited to those of an archaeological, anthropological, biological, geological, medical, veterinary and extra-terrestrial origin; ii) weather maps of various modalities including, but not limited to, visualizing temperature, Doppler radar, precipitation and/or satellite data; iii) multidimensional climatological models simulating of phenomena such as tornadoes, hurricanes, and atmospheric mixing; iv) multidimensional geoscience visualization of seismic, cartographic, topological, strata, and landscape data; v) two dimensional slice imaging and three dimensional volume rendering of microscopic data including, but not limited to, data produced by confocal microscopy, fluorescence microscopy, multiphoton microscopy, electron microscopy, scanning probe microscopy and atomic force microscopy; vi) two and three dimensional visualization of astrophysical data, including but not limited to data produced by interferometry, optical telescopes, radio telescopes, X-ray telescopes and gamma-ray telescopes; and vii) electrochemical and electrical visualization tools for multidimensional imaging in material sciences, including but not limited to scanning electrochemical microscopy, conductive atomic force microscopy, electrochemical scanning tunneling microscopy and Kelvin probe force microscopy.

One embodiment of a colorization process can also be used to generate luminance matched color maps for data beyond three spatial dimensions. Four dimensional data adds a temporal coordinate and =>5 dimensional data includes the four aforementioned dimensions with the additional dimension(s) being fused data of different type(s) (e.g. precipitation map combined with time-varying Doppler radar data). The colorization method disclosed is particularly useful for displaying higher dimensional datasets as both color and its associated luminance represent one dimension of the data.

4. Biomedical Visualization Application

In one embodiment, a specifically designed a color map that mimics the colorization of human anatomy may be used in the aforementioned visualization environment. Nonetheless, the example embodiments contemplate both a generically and perceptually realistic color map for virtual anatomy education and surgical planning. Utilizing luminance matching, the colorization process dynamically creates a perceptual version of this base, or generically realistic color map for any span of CT Hounsfield density data. The level of generic and perceptual realism may be interactively “mixed” with a Perceptual Contrast slider. At the leftmost slider position, the color map is generically realistic. At its rightmost slider position, the color map is perceptually realistic. Any position in-between is a linearly interpolated mix of the two realistic color tables calculated in real-time. The process is designed to easily incorporate non-linear mixing of each color map should the need arise. For other applications, the endpoint color maps may be anything required such as isoluminant and perceptual, isoluminant and generic, generic and arbitrary, etc.

The process also allows the user to exclude luminance matching for specific Hounsfield density regions of interest. If a perceptual, or a mixed percentage perceptual color map is displayed, the user can exclude luminance matching from either the lung, fat, soft tissue, or bone regions of the underlying CT data's Hounsfield unit distribution.

In one embodiment, the regions, other than the excluded region, may contain the perceptual component of the color map. The excluded region may retain the generically realistic color scheme.

In one embodiment, the visualization environment includes grayscale, spectral, realistic, and thermal color maps. The spectral, realistic and thermal schemes may be luminance matched for perceptual correctness via the Perceptual Contrast slider. Again, any arbitrary color map may be luminance matched and thus converted into a perceptual, isoluminant, discrete interval or otherwise defined color table.

One of the advantages of using the realistic color map provided is that colors always map to the same Hounsfield unit values of the full HU window regardless of the size of the imaged window. As a result, all of the colors within a window move seamless between 0% luminance and 100% luminance. This allows the greatest degree of perceptual contrast for a particular window. For example, a small window centered on the liver may display reds and pinks with small density differences discernable due to perceptible differences in luminance. However, if a large window centered on the liver is selected, the liver may appear dark red and would be starkly contrasted with other tissues of differing densities due to differences in both the display color and luminance. This is in contrast to the commonly used grayscale, spectral and thermal tables which dynamically scale with variable HU window width regardless of the size of the window.

Stereoscopic Volume Visualization Engine and Infrastructure

The University of Chicago Department of Radiology's Philips Brilliance 64 channel scanner generates high-resolution donor DICOM CT datasets. In one embodiment, these datasets may be loaded without preprocessing by visualization software. The parallel processing software runs on a nine-node, high performance graphics computing cluster. Each node runs an open source Linux OS and is powered by an AMD Athlon 64 Dual Core 4600+ processor. The volume rendering duties are distributed among eight “slave” nodes. A partial 3D volume reconstruction of the CT dataset is done on each slave node by an Nvidia 7800GT video gaming card utilizing OpenGL/OpenGL Shader Language. The remaining “master” node assembles the renderings and monitors changes in the rendering's state information.

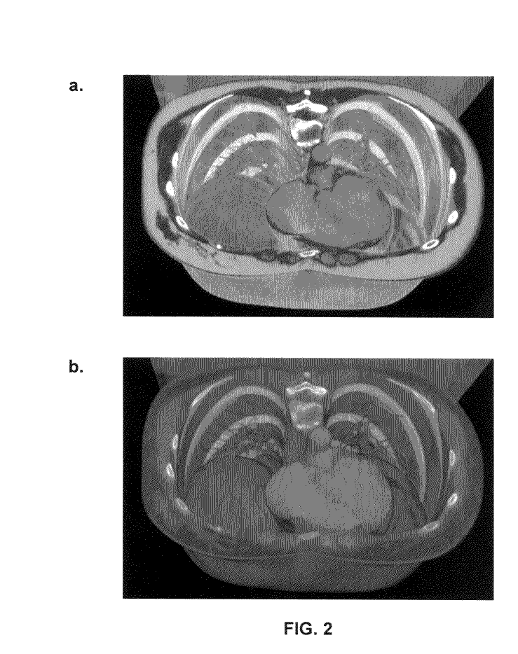

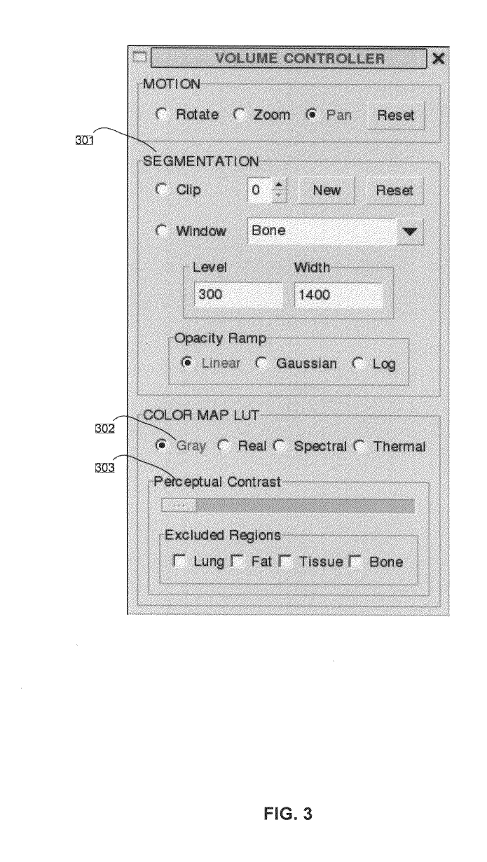

Each eye perspective is reconstructed exclusively among half of the slave nodes, i.e., four nodes render the left or right eye vantage point respectively. The difference in each rendering is an interocular virtual camera offset that simulates binocular stereovision. Both eye perspectives are individually outputted from the master node's dual-head video card to their own respective video projector. The projectors overlap both renderings on a 6′×5′ GeoWall projection screen. Passive stereo volume visualization is achieved when viewing the overlapped renderings with stereo glasses. As shown in FIG. 3, the virtual environment may be controlled via a front-end graphical user interface or GUI. Incidentally, the screenshot of FIG. 3 also shows color map parameters used for generating FIG. 2(a) discussed herein. The volume and GUI are controlled via a single button mouse. The GUI's functionality and available features mimic those available on proprietary radiological workstations. The segmentation pane 301 includes controls for tools such as multi-plane clipping, Hounsfield units (HU) windowing and volume manipulation (e.g., rotate, zoom, and pan) giving surgeons multiple options for interactive control of the rendered volume. The perceptual contrast slider 302 may provide an interactive user control for selecting weights for selecting the target luminance. Additionally, the excluded regions pane 303 may provide a user selectable controls for excluding certain anatomic features or ranges of data.

Volume Rendering and Automated Colorization of Hounsfield CT Data

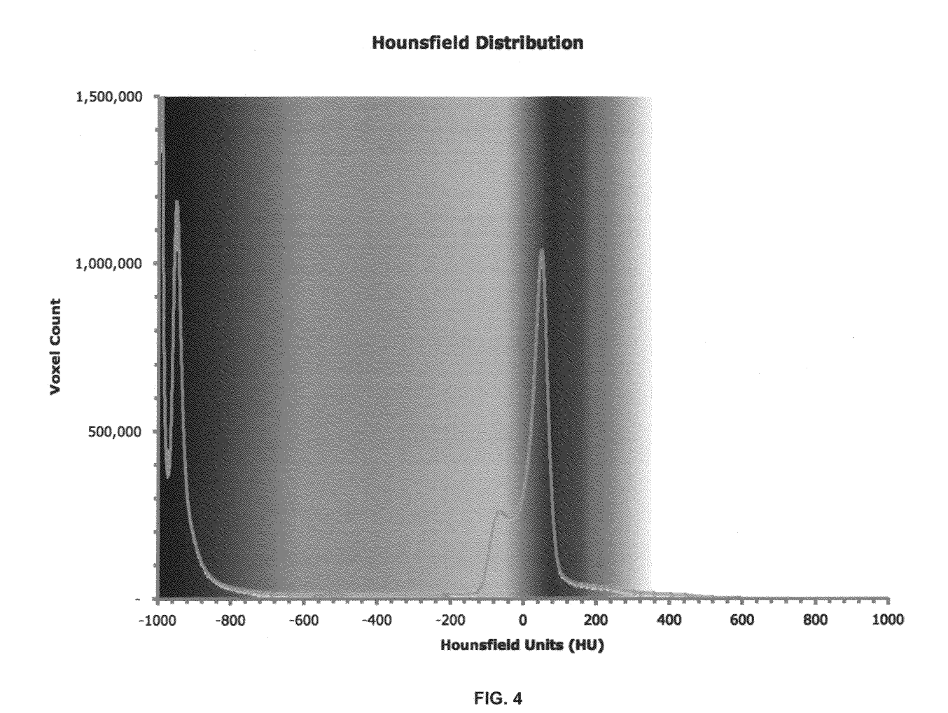

A CT scan produces a Hounsfield unit distribution of radiodensity values. For example, FIG. 4 shows a graph of a 1324 axial slice high-resolution CT dataset (full-body minus head) HU distribution superimposed in blue. Full body CT scans produce HU density distributions with characteristic density peaks that correspond to specific anatomical features. Note that the bone region is not a peak, but a long tail 600 HU wide. HU distributions are similar in data representation to scalar temperature fields used for national weather maps. Both datasets provide scalar data values at specific locations. The spatial resolution of a temperature field is dependent on the number of weather stations you have per square mile. The spatial resolution of the HU distribution depends on the resolution of the CT scanner. State of the art 64 detector scanners can determine HU values per axial image slice for areas less than a square millimeter. The analogy ends there, as the HU distribution is a summation of all the HU scalar values per axial slice whereas there may only be one temperature map. That is, temperature is a function of longitude and latitude whereas the HU distribution is three-dimensional.

During volume rendering, the distance between CT axial image slices determines the Z-axis resolution. The resulting 3D voxel inherits its HU value from the 2D slice. Depending on the rendering algorithms used, the HU voxel value may be continuously changing based on the gradient difference between adjacent slice pixels. The shape of the HU distribution is dependent on what part of the body is scanned much like the shape of a temperature distribution depends on what area of the country you measure. In one embodiment, producing a density based color map scheme that would mimic natural color may include determining the primary density structures of the human body. A natural color range was then determined for each characteristic tissue density type. The volume visualization software utilizes the RGBA color model. RGBA uses the familiar RGB, or red green-blue additive color space, that utilizes the trichromacy blending of these primary colors in human vision. This color model may be represented as a 3 dimensional vector in color space with each axis represented by one of the RGB primary colors and with magnitudes ranging from 0 to 255 for each component.

Opacity Windowing

RGBA adds an alpha channel component to the RGB color space. The alpha channel controls the transparency information of color and ranges between 0% (fully transparent) to 100% (fully opaque). The color process may be integrated with several standard opacity ramps that modify the alpha channel as a function of density for the particular window width displayed. Opacity windowing is a necessary segmentation tool in 2D medical imaging. The example embodiments have extended it to volume rendering by manipulating the opacity of a voxel as opposed to a pixel. For example, the abdomen window is a standard radiological diagnostic imaging setting for the analysis of 2D CT grayscale images. The window spans from −135 HU to 215 HU and clearly reveals a wide range of thoracic features. In one embodiment, the linear opacity ramp may render dataset voxels valued at −135 HU completely transparent, or 0% opaque, and the voxels valued at 215 HU fully visible, or 100% opaque. Since the ramp is linear, the voxel at 40 HU is 50% transparent. All other alpha values within the abdomen window would be similarly interpolated. Voxels with HU values outside of the abdomen window would have an alpha channel value of zero, effectively rendering then invisible. While the linear opacity ramp is described herein, certain further embodiments may optionally employ several non-linear opacity functions to modify the voxel transparency including a Gaussian and logarithmic ramps.

Anatomically Realistic Base Color Map Selection of realistic, anatomical colors was done by color-picking representative tissue image data from various sources such as the Visible Human Project [7]. There was no singular color-picking image source since RGB values for similar tissue varied due to differences in photographic parameters between images. Table 1 displays the final values that were adjusted for effective appearance through feedback from surgeons. Such iterative correction is to be expected as color realism is often a subjective perception based on experience and expectation.

TABLE 1
Generic Realism Color Table for Known HU Distribution Regions

| Tissue type | HU Range | (R_{base}, G_{base}, B_{base}) |
|---|---|---|
| Air filled cavity | −1000 | (0, 0, 0) |
| Lung Parenchyma | −600 to −400 | (194, 105, 82) |
| Fat | −100 to −60 | (194, 166, 115) |
| Soft Tissue | +40 to +80 | (102 [symbol] 153, 0, 0) |
| Bone | +400 to +1000 | (255, 255, 255) |

The embodiment depicted in table 1 provides exact RGB values for each HU range. In other embodiments, however, RGB values may be range within 10%, 5%, or 1%, of the exact RGB values given above. Between the known tissue types, each RGB component value is linearly interpolated. FIG. 4 graphically displays the realistic base color map values from Table 1 including the interpolated colors between tissue types. In the case of the soft tissue, red primary color values are interpolated within the category. Simple assignment of discrete color values to each tissue type without linear interpolation produces images reminiscent of comic book illustrations. The lung appears pink, the liver appears dark red, fat tissue is yellow and bones are white. However, there is nothing natural about this color-contrasted visualization. The smooth interpolation of the colorization process produced the most natural looking transition between tissue categories. More importantly, these linear gradients distinctly highlight tissue interfaces. Theoretically, as x-ray absorption is a non-linear function of tissue density, a corresponding non-linear color blending would be most representative of reality. However, there is no direct way to reverse calculate actual tissue density values from HU as important material coefficients in the CT radiodensity absorption model are not available.

Several CT datasets of healthy human subjects were volume rendered and displayed with this base color table. As mentioned above, the interactive 3D volumes were viewed in stereo by several surgeons and the RGBA values were adjusted to obtain the most realistic images based on the surgeons' recollection from open and laparoscopic surgery. Specifically the thoracic cavity was examined with respect to the heart, the vertebral column, the ribs and intercostals muscles and vessels, and the anterior mediastinum. The abdominal cavity was examined with respect to the liver, gallbladder, spleen, stomach, pancreas, small intestine, colon, kidneys and adrenal glands. The resulting RGBA values and linear transparency ramp resulted in the most realistic colorization with correspondingly high tissue discrimination via consensus among viewing surgeons.

Referring now to FIGS. 2(a) and (b), a generic realistic color map visualization viewed downward at the upper thoracic cavity in the bone window setting (−400 HU to 1000 HU) is depicted. Note the clipped reddish-white heart in the lower left-center and (b) an exact CT dataset reconstruction in grayscale. The bronchia, liver parenchyma and subcutaneous fat layer are not as easily delineated compared to the realistic colorization with white vertebrae (and red discs) in FIG. 2(a). One of ordinary skill in the art will recognize the luminance (Y) from any color space defined as perceptually uniform such as CIELAB and CIELUV can be used by the Luminance Matching Algorithm.

Luminance Matching Conversion of Generic to Perceptual Color Maps

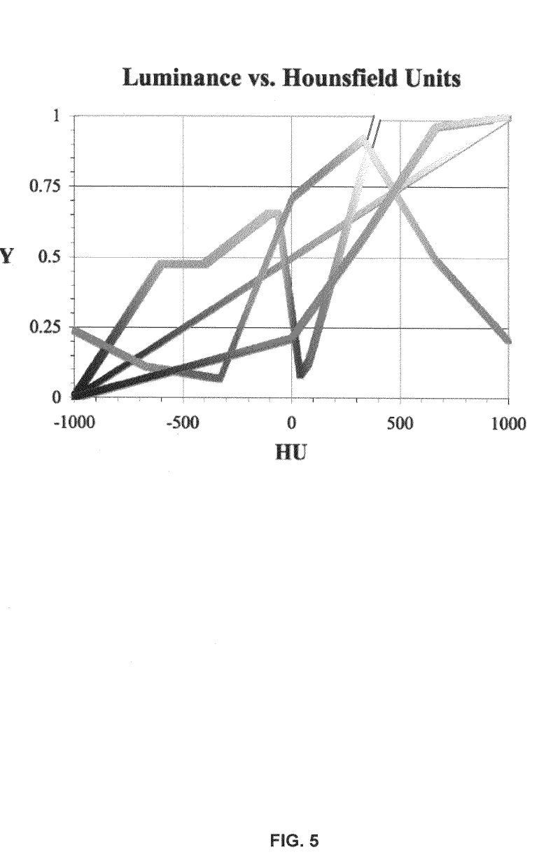

Conversion of a generically hued color map into a perceptual color map is accomplished by luminance matching. Generic color maps refer to those whose luminance does not increase monotonically, i.e., they aren't perceptual. In one embodiment, the GUI has three user selectable color tables including Realistic, Spectral, and Thermal. The Thermal color table is sometimes referred to as a heated body or blackbody color scheme and is an approximation of the sequential colors exhibited by an increasingly heated perfect blackbody radiator. FIG. 5 illustrates the Y(HU) for perceptual grayscale and the generic versions of the realistic, spectral, and thermal color tables over the full CT data range (HU window). The grayscale, spectral, and thermal tables dynamically scale with variable HU window widths, i.e., the shape of the Y(HU) plot remains the same regardless of the span of abscissa values. In contrast, the realistic color schemes always map to the same HU values of the full HU window regardless of the abscissa width. From FIG. 5 it should be noted that the generic form of the thermal color map is already increasingly monotonic in HU. Though the monotonicity is not linear, it is not surprising that thermal maps are deemed almost as natural as grayscale by human users [5].

Luminance matching takes advantage of the fact that HSV grayscale is a perceptual color scheme due to its increasing luminance monotonicity. Matching the luminance of a generic color map to that of grayscale for a given HU window may yield colorized voxels with the same perceived brightness as their grayscale counterparts. The luminance of hued color maps effectively becomes a linear function of HU, i.e., Y(HU).

Luminance is calculated using a color space that defines a white point, which precludes the HSV and linear, non-gamma corrected RGB color spaces used in computer graphics and reported in this paper's data tables. In one embodiment, the color space is sRGB (IEC 61966-2.1), which is the color space standard for displaying colors over the Internet and on current generation computer display devices. Using the standard daylight D65 white point, luminance for the sRGB is calculated by Eq. (3). One of ordinary skill in the art will recognize that any colormetrically defined, gamma-corrected RGB color space such as Adobe RGB (1998), Apple RGB, or NTSC RGB may be substituted resulting in different CIE transformation coefficients for equation 3. Note that correct luminance calculation requires linear, non-gamma corrected RGB values [8].

Y(HU)color=c1*Rcolor+c2*Gcolor+c3*Bcolor Eq. (3)

where: c1=0.212656; c2=0.715158; c3=0.0721856

For a given HU window, RGB grayscale values range from 0 to 255. Grayscale luminance is calculated by Eq. (4):

Y(HU)grayscale=c1*Rgrayscale+c2*Ggrayscale+c3*Bgrayscale Eq. (4)

If Ycolor is greater than Ygrayscale, the value (V), or brightness component of HSV, is decreased in RGB space and the luminance is iteratively recalculated until the two luminance values equal. Manipulating HSV components in the RGB color space optimizes the luminance matching algorithm by eliminating the computationally inefficient conversion between HSV and RGB.

If Ycolor is less than Ygrayscale, there are two options to increase Ycolor. First V is increased. If V reaches Vmax (100%) and Ycolor is still less than Ygrayscale, then saturation is decreased. Decreasing saturation is necessary as no fully bright, completely saturated hue can match the luminance value of the whitest grays at the top of the grayscale color map. Once the Y values are matched, the resultant perceptualized RGB values are ready for color rendering.

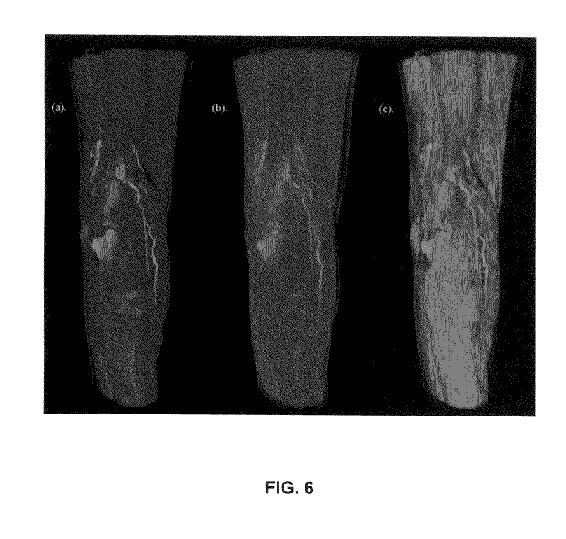

FIG. 1 shows a comparison of generic and perceptual color maps generated in accordance with the colorization process for visualizing the left side view of the human heart along with bronchi, vertebrae, liver and diaphragm. Particularly, FIGS. 1(a), 1(c), 1(e), and 1(g) are perceptual versions of the grayscale, realistic, spectral, and thermal color maps respectively, whereas FIGS. 1(b), 1(d), 1(f) are the generic versions of the realistic, spectral, and thermal maps. FIG. 6 illustrates the potential of perceptually realistic color maps. Note how the hamstrings and upper gastrocnemius muscles surrounding the popliteal fossa are clearly delineated in FIG. 6(a) but ill defined in FIG. 6(b). Luminance matching displayed in FIG. 6(c) merges the perceptually desirable grayscale luminance with the clinically desirable realistic muscle colorization resulting in a visualization that exhibits the best of both color tables.

Natural colorization of three-dimensional volume rendered CT datasets produces intuitive visualizations for surgeons and affords advantages over grayscale. Perceptually realistic colorization with adequate luminosity contrast multiplies these advantages by producing color maps that enhance visual perception of complex, organic shapes thus giving the surgeon a greater insight into patient specific anatomic variation, pathology, and preoperative planning.

The colorization process may be extended to match non-monotonically increasing luminance distributions. For example, matching the desired luminance to some grayscale luminance value, i.e., Yconstant, easily creates isoluminant color maps. Note that in an isoluminant color scheme, Y is not a function of HU.

Mixing Perception and Reality

In one embodiment, the GUI allows a user to choose the degree of realism and perceptual accuracy desired for a particular color map via the Perceptual Contrast slider. This allows the user to view generic color maps in an arbitrary mixture of their generic or perceptual form. Alternatively, the user can choose to move the slider to the end points, which may represent generic color mapping (including anatomic realism) on the left and perceptual on the right. The slider mixes varying amounts of realism with perceptual accuracy by having Ycolor match a linearly interpolated luminance as shown in Eq. (5).

Y(HU)interpolated=(1.0−P)*Y(HU)color+P*Y(HU)grayscale Eq. (5)

Yinterpolated is parameterized by the perceptual contrast variable P which ranges from 0.0 to 1.0 inclusive, and is the degree of mixing between generic and perceptual color mapping. The Perceptual Contrast slider on the GUI controls P's value. For any given P, Yinterpolated is once again compared to Ygrayscale. The colorization process once again dynamically calculates the HSV brightness and/or saturation changes necessary for the Y values to match.

The colorization process further allows for sections of the anatomically realistic color map to overlap perceptual and generic color map values by selective exclusion of characteristic HU distribution regions. This is useful as realism is lost in some HU windows from luminance matching. For example, the fat color scheme tends to desaturate from tan-lemon yellow to a murky dark brownish-green. Even though this biases the visualization of the underlying HU voxel data, realistic fat colorization may make complex anatomy appear natural and thus easier to interpret. In one embodiment, the interface has checkboxes that allow the exclusion the fat region from the luminance matching allowing it to retain its realistic color while letting the other regions display their color values with perceptual accuracy. The lung, tissue, and bone regions can also be selectively excluded from perceptual contrast conversion.

### Pseudocode for Luminance Matching According to One Embodiment

display User selected HU window with Generic Color Map
call Get_Perceptual_Contrast_Percentage_from_Slider
if Perceptual Contrast Percentage equals 100%

print “Ymatch equals Ygrayscale. The generated color map will be perceptual”

else

print “Ymatch is a linearly weighted mix of Ycolor and Ygrayscale.”

for each HU Number in the User selected HU window

call Get_HU_Number's_RGB_Triplet_from_Generic_Color_Map_ID_LUT
call Calculate_HU_Number's_Ycolor_using_RGB_Triplet
call Calculate_HU_Number's_Ymatch_using_RGB_Triplet
while Ycolor is greater than Ymatch

call Decrease_HSV_Triplet's_Value_Component (e.g. in_RGB_Color_Space)
call Calculate_HU_Number's_Ycolor_using_RGB_Triplet

while Ymatch is greater than Ycolor

if Value Component Value is less than 100%

call Increase_HSV_Triplet's_Value_Component (e.g. in_RGB_Color_Space)

else

| | | |
|---|---|---|
| call | Decrease_HSV_Triplet's_Saturation_Component | (e.g. |

in_RGB_Color_Space)

call Calculate_HU_Number's_Ycolor_using_RGB_Triplet

call Exclude_HU_Region (optional)
save HU_Number's_RGB_Triplet_to_Luminance_Matched_Color_Map_ID_LUT

display User selected HU window with Luminance Matched Color Map

The computer code set forth above may be written in any programming language such as C, C++, VISUAL BASIC, JAVA, Pascal, Fortran, etc. for which many commercial compilers may be used to create executable code. Furthermore, the executable code may be run under any operating system.

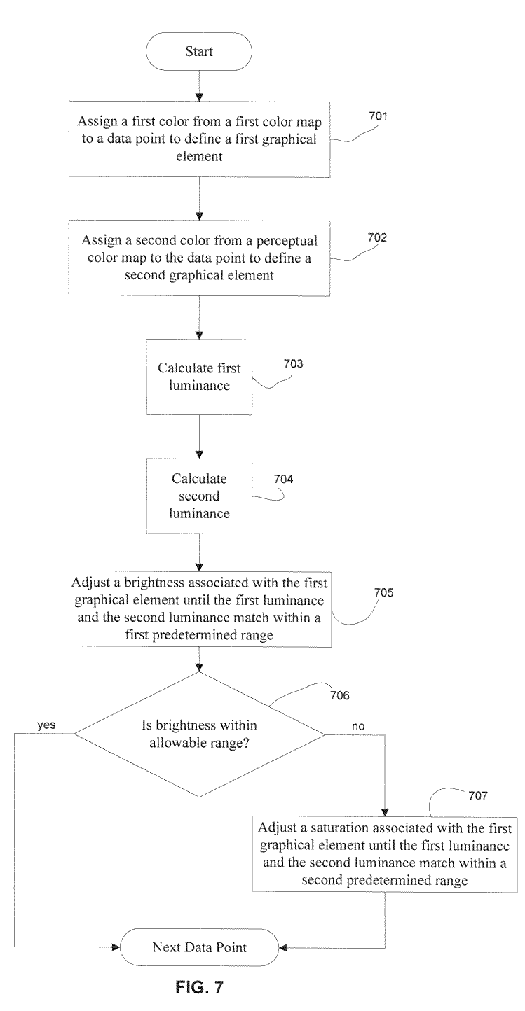

Turning now to FIG. 7, a flowchart of a method for colorizing an image is depicted according to one embodiment of the present invention. In step 701, the method includes assigning a first color from a first color map to a data point to define a first graphical element. Then, in step 702, a second color from a perceptual color map is assigned to the data point to define a second graphical element. In step 703 a luminance for the first graphical element is calculated and in step 704 a luminance for the second graphical element is calculated. The color brightness of the data point is adjusted (increased or decreased) in step 705 until the first luminance matches the second luminance within a predetermined range. In one embodiment, the range may be zero, meaning that an exact match is required. Alternatively, the range may include a range of percentage of match or a range of luminance values. In one embodiment, the range may be centered on the second luminance value. Alternatively, the range may be defined to include the second luminance at any position within the range. If it is determined that the color brightness has reached a threshold value in step 706, no further adjustments to the brightness may be made. Rather, in step 707, a color saturation of the data point may be adjusted until the first luminance and the second luminance match within a second predetermined range. In a further embodiment, the first predetermined range and the second predetermined range may be the same. If, however, color brightness is still within the allowable range and the relationship between the first luminance and the second luminance is reached in step 705, then a next data point is processed or the method ends.

In one embodiment, the method may include recalculating the first luminance iteratively after an adjustment of one of the brightness and the saturation of the first graphical element. For example, the brightness and/or saturation may be adjusted in incremental steps. After each incremental step, the first luminance may be recalculated and compared against the second luminance to determine whether a match has been reached.

The method may also include selecting a subset of data points from a multidimensional dataset, the subset of data points having values within a specified range of values. In a certain embodiment, the multidimensional dataset is associated with a radiological image. For example, the multidimensional data set may include a radiological image of a thoracic cavity. The subset may be selected so that only those data points that have HU values that correspond to body tissue are colored. This is generally called HU windowing.

In still another embodiment the method may include excluding one or more of the data points from the subset of data points. For example, certain colors or density ranges may be deselected. For example, the data points having HU values that fall within a range that corresponds to the density of bones may be deselected.

In these various embodiments, the first color map may include colors that mimic coloration of an anatomic feature of a human body. For example, Table 1 above describes a color map that may mimic coloration of an anatomic feature of the human body. The perceptual color map may include a grayscale color map. Nonetheless, one of ordinary skill in the art will recognize that other perceptual color maps may be used in conjunction with the example embodiments.

In a further embodiment, the method described in FIG. 7 may be carried out either in parallel or serially on a plurality of data sets, each generated by a multichannel imaging system. For example, the method may be carried out simultaneously for a plurality of data sets, where each data set is generated by a separate data source (e.g., multiple sensors, detectors, antennas, etc.). For each dataset, a representative base color may be selected, the example embodiments may further generate a colorized map, and the multiple images may be combined via standard techniques (such as Maximum Intensity Projection) to create a multi-color perceptually correct rendering of the original multi-channel data.

Indeed, the example embodiments may be expandable to up to N channels of operation. For example, the method may include assigning a third color to a second data point generated by a multichannel data source to define a third graphical element, assigning a fourth color from a perceptual color map to the data point to define a fourth graphical element, calculating a third luminance for the third graphical element, calculating a fourth luminance for the fourth graphical element, adjusting a brightness associated with the third graphical element until the third luminance and the fourth luminance match, adjusting a saturation associated with the third graphical element until the third luminance and the fourth luminance match in response to a determination that the brightness parameter associated with the third graphical element has reached a threshold value, and displaying one of the first graphical element and the third graphical element according to a predetermined display scheme. In a further embodiment, adjusting the saturation is performed in response to a determination that the brightness parameter associated with the first graphical element has reached a threshold value.

The functions and processes described above may be implemented, for example, as software or as a combination of software and human implemented procedures. The software may comprise instructions executable on a digital signal processor (DSP), application-specific integrated circuit (ASIC), microprocessor, or any other type of processor. The software implementing various embodiments of the present invention may be stored in a computer readable medium of a computer program product. The term “computer readable medium” includes any physical medium that can store or transfer information. Examples of the computer program products include an electronic circuit, semiconductor memory device, random access memory (RAM), static RAM (SRAM), dynamic RAM (DRAM), synchronous DRAM (SDRAM), read only memory (ROM), erasable ROM (EROM), erasable programmable ROM (EPROM), electrically erasable programmable ROM (EEPROM), flash memory, floppy diskette, compact disk (CD), optical disk, hard disk, or the like. The software may be downloaded via computer networks such as the Internet or the like.

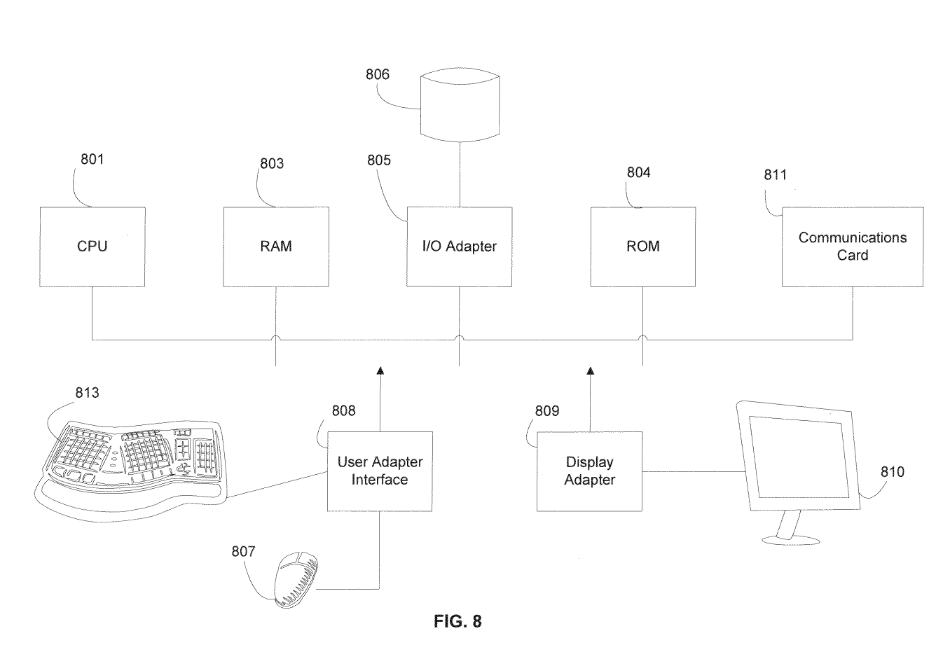

FIG. 8 illustrates a computer system adapted to use embodiments of the present invention (e.g., storing and/or executing software associated with these embodiments). Central processing unit (CPU) 801 is coupled to system bus 802. CPU 801 may be any general purpose CPU. However, embodiments of the present invention are not restricted by the architecture of CPU 801 as long as CPU 801 supports the inventive operations as described herein. Bus 802 is coupled to RAM 803, which may be SRAM, DRAM, or SDRAM. ROM 804 is also coupled to bus 802, which may be PROM, EPROM, or EEPROM.

Bus 802 is also coupled to input/output (“I/O”) controller card 805, communications adapter card 811, user interface card 808, and display card 809. I/O adapter card 805 connects storage devices 806, such as one or more of a hard drive, a CD drive, a floppy disk drive, a tape drive, to the computer system. I/O adapter 805 is also connected to a printer (not shown), which would allow the system to print paper copies of information such as documents, photographs, articles, and the like. Note that the printer may be a printer (e.g., dot matrix, laser, and the like), a fax machine, scanner, or a copier machine. Communications card 811 is adapted to couple the computer system to a network which may be one or more of a telephone network, a local (“LAN”) and/or a wide-area (“WAN”) network, an Ethernet network, and/or the Internet. Additionally or alternatively, communications card 811 is adapted to allow the computer system to communicate with an image acquisition device or the like. User interface card 808 couples user input devices, such as keyboard 813, pointing device 807, and the like, to computer system 800. Display card 809 is driven by CPU 801 to control the display on display device 810.

As a person of ordinary skill in the art may readily recognize in light of this disclosure, color perception is an intrinsic quality of both the actual and virtual surgical experience and is a psychophysical property determined by the visual system's physiological response to light brightness. This response to radiance is parameterized by luminosity and is critical in the creation of multi-hued color maps that accurately visualize underlying data. Disclosed herein is an interactive colorization process capable of dynamically generating color tables that integrate the perceptual advantages of luminance controlled color maps with the clinical advantages of realistically colored virtual anatomy. The color scale created by the process possesses a level of realism that allows surgeons to analyze stereoscopic 3D CT volume reconstructions with low visualization effort. Furthermore, luminous contrast is optimized while retaining anatomically correct hues. In one embodiment, surgeons can visualize the future operative field in the stereoscopic virtual reality system and see perceptually natural and realistic color mapping of various anatomical structures of interest. Such colorization provides a powerful tool not only for improving surgical preoperative planning and intraoperative decision-making but also for the diagnosis of medical conditions. The process may be easily extended to create perceptual or isoluminant versions of any generic color map scheme and thus may be easily adapted to a broad range of visualization applications.

Furthermore, the example embodiments may be used to enable simultaneous multidimensional visualization of electron microscopy data for biomedical research. In this circumstance, geographically constant regions may be imaged with multiple modalities to obtain multiple images or data sets. For each image, a representative base color may be selected, the example embodiments may further generate a colorized intensity map, and the multiple images may be combined via standard techniques (such as Maximum Intensity Projection) to create a multi-color perceptually correct rendering of the original multi-channel data.

Although certain embodiments of the present invention and their advantages have been described herein in detail, it should be understood that various changes, substitutions and alterations may be made without departing from the spirit and scope of the invention as defined by the appended claims. Moreover, the scope of the present invention is not intended to be limited to the particular embodiments of the processes, machines, manufactures, means, methods, and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods, or steps.

### REFERENCES

The following references, to the extent that they provide exemplary procedural or other details supplementary to those set forth herein, are specifically incorporated herein by reference.
Jackson and Thomas, In: Introduction to CT Physics. In: Cross-sectional imaging made easy, London: Churchill Livingstone, 3-16, 2004.
Johnson and Fairchild, In: Visual psychophysics and color appearance, Sharma (Ed.), Digital Color Imaging Handbook, Pa., CRC Press, 115-172, 2003.
Kindlmann et al., In: Face-based luminance matching for perceptual colormap generation, Proc. Conf. Visualiz., MA, USA. Washington D.C., IEEE Computer Society, 299-306, 2002.
Mantz, In: Digital and Medical Image Processing [monograph on the Internet]. Unpublished; 2007.
Rogowitz and Kalvin, In: The “Which Blair Project”. A quick visual method for evaluating perceptual color maps. Proc. Conf. Visualiz., San Diego, Calif., USA. Washington D.C., IEEE Computer Society, 183-190, 2001.
Rogowitz et al., Com Ph., 10(3):268-273, 1996.
Stevens and Stevens, J. Opt. Soc. Am., 53:375-385, 1963.

What is claimed is:

1. A method comprising:
assigning a first color from a first color map to a data point to define a first graphical element;
assigning a second color from a perceptual color map to the data point to define a second graphical element;
calculating a first luminance for the first graphical element;
calculating a second luminance for the second graphical element;
adjusting a brightness associated with the first graphical element until the first luminance and the second luminance match within a first predetermined range; and
adjusting a saturation associated with the first graphical element until the first luminance and the second luminance match within a second predetermined range.

2. The method of claim 1, where adjusting the saturation is performed in response to a determination that the brightness parameter associated with the first graphical element has reached a threshold value.

3. The method of claim 1, where the first luminance is recalculated iteratively after an adjustment of one of the brightness and the saturation of the first graphical element.

4. The method of claim 1, further comprising selecting a subset of data points from a multidimensional dataset, the subset of data points having values within a specified range of values.

5. The method of claim 4, where the multidimensional dataset is associated with a radiological image.

6. The method of claim 4, further comprising excluding one or more of the data points from the subset of data points.

7. The method of claim 1, where the first color map comprises colors that mimic coloration of an anatomic feature of a human body.

8. The method of claim 1, where the perceptual color map comprises a grayscale color map.

9. The method of claim 1, where the first predetermined range is equal to the second predetermined range.

10. The method of claim 1, further comprising:
assigning a third color to a second data point generated by a multichannel data source to define a third graphical element;
assigning a fourth color from a perceptual color map to the data point to define a fourth graphical element;
calculating a third luminance for the third graphical element;
calculating a fourth luminance for the fourth graphical element;
adjusting a brightness associated with the third graphical element until the third luminance and the fourth luminance match;
adjusting a saturation associated with the third graphical element until the third luminance and the fourth luminance match in response to a determination that the brightness parameter associated with the third graphical element has reached a threshold value; and
displaying one of the first graphical element and the third graphical element according to a predetermined display scheme.

11. The method of claim 11, where adjusting the saturation is performed in response to a determination that the brightness parameter associated with the first graphical element has reached a threshold value.

12. A method comprising:
assigning a first color from a first color map to a data point to define a first graphical element;
assigning a second color from a perceptual color map to the data point to define a second graphical element;
calculating a first luminance for the first graphical element;
calculating a second luminance for the second graphical element;
calculating a target luminance according to selectable weights of the first luminance and the second luminance;
adjusting a brightness associated with the first graphical element until the first luminance and the target luminance match; and
adjusting a saturation associated with the first graphical element until the first luminance and the second luminance match.

13. The method of claim 12, where adjusting the saturation is performed in response to a determination that the brightness parameter associated with the first graphical element has reached a threshold value.

14. The method of claim 12, where the weights are selected through a user adjustable interface control.

15. The method of claim 14, where the interface control comprises a slider.

16. An apparatus comprising:
a memory for storing a data point associated with an image; and
a processor, coupled to the memory, configured to:
assign a first color from a first color map to a data point to define a first graphical element;
assign a second color from a perceptual color map to the data point to define a second graphical element;
calculate a first luminance for the first graphical element;
calculate a second luminance for the second graphical element;
adjusting a brightness associated with the first graphical element until the first luminance and the second luminance match within a first predetermined range; and
adjust a saturation associated with the first graphical element until the first luminance and the second luminance match within a second predetermined range.

17. The apparatus of claim 16, where adjusting the saturation is performed in response to a determination that the brightness parameter associated with the first graphical element has reached a threshold value.

18. The apparatus of claim 16, further comprising an image capture device configured to capture the image.

19. The apparatus of claim 18, where the image capture device comprises a multichannel image capture device.

20. The apparatus of claim 16, further comprising a display configured to display a colorized image.

21. The apparatus of claim 16, further comprising a user interface configured to allow a user to select a combination of the first luminance and the second luminance for calculating a target luminance.

22. A computer readable medium comprising computer-readable instructions that, when executed, cause a computing device to perform the steps of:
assigning a first color from a first color map to a data point to define a first graphical element;
assigning a second color from a perceptual color map to the data point to define a second graphical element;
calculating a first luminance for the first graphical element;
calculating a second luminance for the second graphical element;
adjusting a brightness associated with the first graphical element until the first luminance and the second luminance match within a first predetermined range; and
adjusting a saturation associated with the first graphical element until the first luminance and the second luminance match within a second predetermined range.

23. The computer readable medium of claim 22, where adjusting the saturation is performed in response to a determination that the brightness parameter associated with the first graphical element has reached a threshold value.
